(19) United States
(12) Patent Application Publication
(10) Pub. No.: US 2022/0236154 A1
(43) Pub. Date: Jul. 28, 2022

(54) PDMS GRANULAR COATED VIAL

(71) Applicant: PERKINELMER HEALTH SCIENCES, INC., Waltham, MA (US)

(72) Inventors: Tai Van Truong, Taylorsville, UT (US); Nathan Porter, Kaysville, UT (US); Edgar D. Lee, Wallsburg, UT (US)

(21) Appl. No.: 17/617,467

(22) PCT Filed: Jul. 1, 2020
(86) PCT No.: PCT/US2020/040576

§ 371 Date: Dec. 8, 2021

Related U.S. Application Data
(60) Provisional application No. 62/869,463, filed on Jul. 1, 2019.

(51) Int. Cl. G01N 1/40

(52) U.S. Cl. CPC G01N 1/405

(57) ABSTRACT

The present invention is a system and method for improving extraction of analytes from a solution by disposing a plurality of polydimethylsiloxane(PDMS) particles in a thin layer on an inner wall of an extraction vial, by increasing a surface area and volume of particles disposed to extract analytes from the solution and thereby increasing extraction capacity and speed for gas chromatography-mass spectrometry (GC-MS) analysis.

### BACKGROUND

### Field of the Invention

This invention relates generally to performing sample preparation in analytical chemistry, and more specifically to improving techniques for extraction of a sample for analysis.

### Description of Related Art

Sample preparation procedures in analytical chemistry are often times laborious and time consuming. One reason is that extraction techniques may have unique specifications and require specific tools and special instrumentation. Furthermore, these requirements may not be readily applicable to in-field applications where analysis may need to be performed quickly and efficiently. Another complication may be that the analysis may be performed by an operator with limited training, such as a technician or soldier using field-portable equipment.

Extraction techniques that may need to be performed in the field may include solid phase extraction (SPE), solid phase micro extraction (SPME), needle trap (NT), stir bar sorptive extraction (SBSE) which is mainly used in-lab, and QuEChERS, which is an acronym for quick, easy, cheap, effective, rugged and safe. These techniques may have simplified the determination of multiple target analytes in diverse sample matrices. However, these extraction techniques may not satisfy all requirements for fast analysis, low limits of detection (low ppb), and ease of use in the field.

Given that field testing may be conducted using limited sample preparation tools and equipment and be performed by relatively untrained operators, and that sample preparation techniques for field testing may also combine selected features of the different extraction techniques listed above, it would be an advantage over the prior art to provide a system and/or a method for improving in-field chemical analysis. It would also be an advantage to provide a system and/or a method that reduces or eliminates the effect of water on the analysis process used with thermal desorption, purge and trap, head space and GC/GCMS.

### BRIEF SUMMARY

The present invention is a system and method for improving extraction of analytes from a solution by disposing a plurality of polydimethylsiloxane(PDMS) particles in a thin layer on an inner wall of an extraction vial by increasing a surface area and volume of particles disposed to extract analytes from the solution and thereby increasing extraction capacity and speed for gas chromatography-mass spectrometry (GC-MS) analysis.

In a first aspect of the invention, PDMS particles are disposed in a thin layer in a thin film material on an inner wall of an extraction vial.

In a second aspect of the invention, water is removed from the extraction vial to thereby facilitate extraction of compounds that require high temperatures to move them into a headspace within the extraction vial.

These and other embodiments of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a cross-sectional view of a extraction vial that has been coated with a thin film coating that is embedded with PDMS particles in accordance with the embodiments of the invention.

FIG. 2 is a comparison of a thin film coating versus a PDMS coating to thereby demonstrate the increase in surface area for extraction.

### DETAILED DESCRIPTION

Reference will now be made to the drawings in which the various embodiments of the present invention will be discussed so as to enable one skilled in the art to make and use the invention. It is to be understood that the following description illustrates embodiments of the present invention and should not be viewed as narrowing the claims which follow.

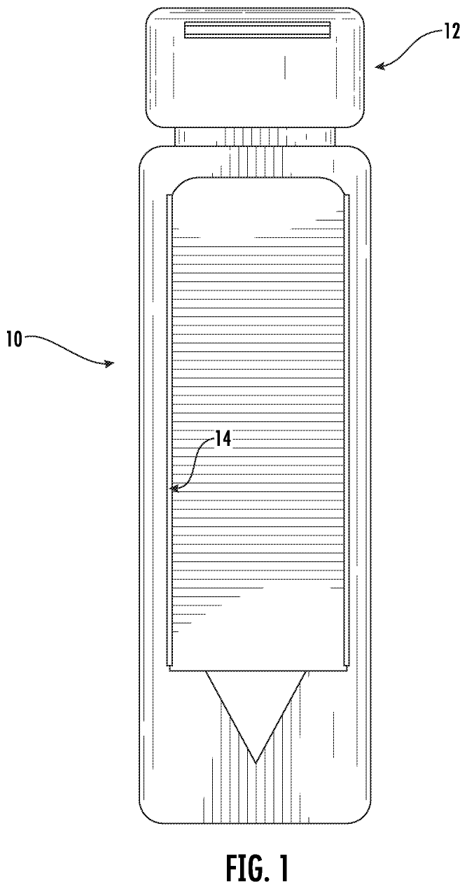

A first embodiment of the invention is shown in FIG. 1. In FIG. 1, an extraction vial 10 having a cap 12 is shown in a profile view. The inside of the extraction vial 10 includes a coating 14 of polydimethylsiloxane(PDMS) in a granular form. The PDMS granular coated extraction vial (PDMS GCV) 10 may be used in a polymer coated vial (PCV) extraction technique.

PCV extraction is a method for concentration and extraction of trace organic compounds found in an aqueous sample or water for gas chromatography-mass spectrometry (GC-MS) analysis. These compounds may be semi-volatile organic compounds (SVOCs) and they may be volatile organic compounds (VOCs).

Creating the PDMS GCV may be accomplished by disposing a plurality of small (e.g. typically less than 25 μm) PDMS particles on an inner wall of the extraction vial 10 to form a thin layer of PDMS. The PDMS layer forms a coating 14 that may be either smooth or porous, and which provides a highly interactive surface. The PDMS extraction vial provides a large surface area for interacting with a sample.

Regarding the porous coating, the pores may be formed in the coating 14 during cross linking and conditioning of the coating at a high temperature resulting in evaporation of the solvent between the PDMS particles.

Prior art coated vials may be referred to as thin film coated vials and were comprised of a coating having a substantially smooth surface, wherein a substantially smooth surface may be defined as a surface that does not intentionally include surface features that act to increase a surface area for collecting analytes from a solution.

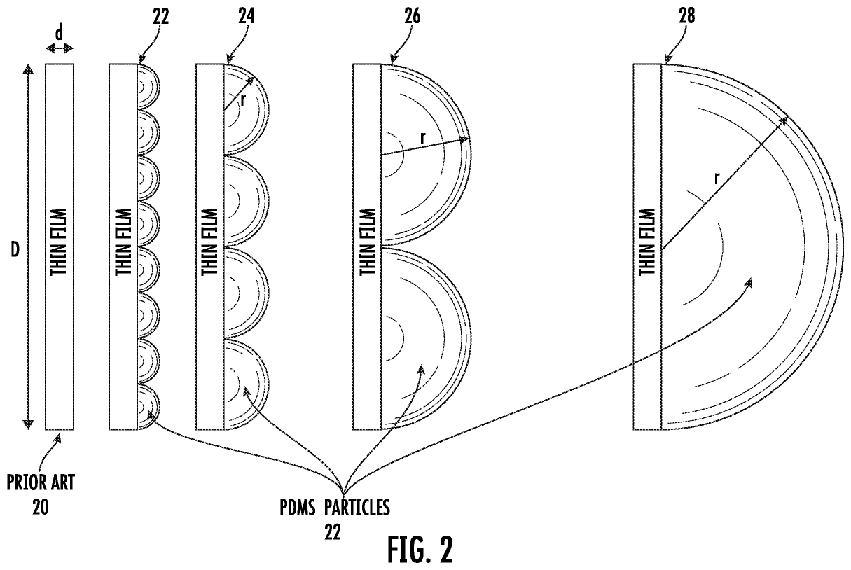

FIG. 2 shows a comparison of some embodiments of the invention and the prior art. It should be understood that FIG. 2 is not showing the curvature of the thin film coating or the PDMS coating within the extraction vial 10 but is only being used to demonstrate a comparison of the thickness of the thin film and the PDMS coatings.

Specifically, FIG. 2 shows a first thin film coating 20 from the prior art having a depth d and a length D. FIG. 2 also shows four embodiments (22, 24, 26 and 28) of the invention next to the thin film coating 20 that vary in the size and shape of the PDMS particles 22 that are disposed on the PDMS coating 14. As shown, the PDMS particles 22 are embedded into or adhered to a thin film coating 20 to hold them in place on the inner wall of an extraction vial. The objective is to substantially increase the surface area of the PDMS coating 14 with the use of the PDMS particles 22 as compared to the thin film coating 20 without PDMS particles.

A PDMS coated extraction vial 10 may improve the surface area by a factor of at least 3.3561 and improve the volume by a factor of at least 1.2618 using the PDMS particles 22, independent from the dimensions D, d and r as compared to the thin film coating 20. These factors do not include the effect of pores in the PDMS coating 14. Accordingly, the surface area of the PDMS coating 14 will be even greater that that calculated above.

One advantage of the embodiments of the invention is that the increased surface area within the PDMS coated extraction vial 10 may result in analytes in a solution going into the sorbent material at a faster rate and at a higher capacity when compared with vials having the thin film coating 20. The efficiency of the PDMS coated extraction vials 10 at extracting the analytes may be much improved over existing sample preparation methods including solid phase micro extraction, stir bar sorptive extraction, and QuEChERS.

It should be understood that the thin film coating material into which the PDMS particles are embedded may be any suitable thin film coating material that does not interfere with the performance of the PDMS particles as is known to those skilled in the art. Similarly, any type of particles may be embedded into the thin film coating on the vials as long as the particles perform the function of extracting analytes from a solution. Thus, particles other than PDMS should be considered to be within the scope of the claims as long as those particles increase the surface area inside the extraction vial 10.

One of the advantages of the PDMS GCV 10 is that interference from water with operation of the GC-MS or any other detector may be reduced and/or prevented because water may be eliminated completely from the extraction vial. As is known to those skilled in the art, water and water vapor may interfere with detection instrument operation and performance. For example, water vapor may be retained by an adsorbent in the extraction vial, it may mask available sites of the adsorbent, it may displace compounds, and it may reduce the purging flow rate when condensing inside the absorption tube or needle trap. Water and water vapor may also alter split flow ratios during desorption, may cause chromatographic separation issues, may blow out the FID flame, and it may reduce the vacuum of an MS detector and degrade EMP, especially for small vacuum chamber MS. Accordingly, by eliminating all traces of water from the extraction vial as is possible with the embodiments of the invention, performance is significantly improved.

For example, water may simply be poured out of the extraction vial once analytes are extracted. Analyte extraction may take no more than a few minutes. With the water eliminated from the extraction vial, the extraction vial may then be heated to push the analytes into the headspace of the extraction vial. The extraction vial may be heated to whatever temperature is typically needed to obtain both VOCs and SVOCs. A typical heating temperature may be 300 degrees Celsius. However, the PDMS GCV 10 may be heated to higher temperatures without damaging the PDMS coating 14.

It is noted that when an extraction vial is heated to higher temperatures, there is often something besides water in the extraction vial such as a polymer or some other material from which analytes are being extracted. However, heavy compounds that are disposed in water cannot typically be heated high enough to get them to go into the extraction vial headspace. By substantially reducing if not completely eliminating water from the extraction vial, it is now possible to extract the heavier compounds from a water solution once the water is removed.

One particular advantage of the embodiments of the invention that may now be more obvious to a user is that the sensitivity of a detection system may be much improved because of the high volume of the VOCs and SVOCs that are extracted using the PDMS GCV.

Another advantage of the embodiments may be that the extraction process is faster because there is no longer a need to heat water in the PDMS coated extraction vial 10 because it has been substantially reduced or eliminated. Heating the water normally requires a significant amount of time. Removal of the water enables the headspace to reach equilibrium faster because only the coated extraction vial needs to be heated.

Regarding equilibrium, headspace equilibrium may also be reached faster using a PDMS coated extraction vial because of the higher concentration or capacity of the analytes in the PDMS GCV because of the increased surface area of the PDMS coating.

Another advantage may be an improvement in extraction efficiency. Extraction speed and capacity may be improved because of the surface area and volume of the PDMS particles of the PDMS GCV.

Another advantage may be the diversity of applications for many sample preparation and detection instruments. Such instruments may include but should not be considered as limited to SPS-3 Purge and Trap, Head Space Turbomatrix, hand-portable or desktop GC and GC-MS, and HPLC.

It is noted that re-extraction may be performed with solvent to extract the analytes from the coating, and then followed, if necessary, by a concentration step by letting the solvent evaporate. The solvent-free sample may then be injected into an instrument by a conventional micro-syringe or a coiled wire filament.

The embodiments of the invention may also enlarge the applicable analytes with wide volatility range.

Finally, the PDMS Granular coated extraction vial 10 is easy to use, fast to use and has a low cost in use and in manufacturing while being effective and environmentally friendly.

In summary, the embodiments of the invention are directed to a method for improving a sample extraction technique from solution, the method comprising the steps of: 1) providing an extraction vial for extracting analytes from solution, 2) disposing a thin film coating on an inner surface of the extraction vial, 3) disposing a coating of polydimethylsiloxane (PDMS) particles on the thin film coating, wherein the PDMS coating adheres to the thin film coating and increases a surface area of the inner surface of the extraction vial, and wherein the PDMS is a sorbent material, 4) pouring a solution containing analytes into the extraction vial, 5) waiting a sufficient period of time for the analytes in the solution to be absorbed or adsorbed by the PDMS coating, 6) pouring the remaining solution from the extraction vial, 7) sealing the extraction vial, 8) heating the extraction vial to thereby push the analytes into a headspace volume inside the extraction vial, and 9) delivering the analytes to a measuring instrument for detecting and measuring the analytes.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. It is the express intention of the applicant not to invoke 35 U.S.C. § 112, paragraph 6 for any limitations of any of the claims herein, except for those in which the claim expressly uses the words ‘means for’ together with an associated function.

1. A system for increasing a surface area of particles for extracting analytes from a solution, said system comprised of:
an extraction vial for extracting analytes from solution;
a thin film coating disposed on an inner surface of the extraction vial; and a coating of polydimethylsiloxane (PDMS) particles disposed on the thin film, wherein the PDMS coating increases a surface area of the inner surface of the extraction vial, and wherein the PDMS is a sorbent material.

2. The system as defined in claim 1 wherein the PDMS coating is substantially smooth and non-porous.

3. The system as defined in claim 1 wherein the PDMS coating is substantially rough and porous.

4. The system as defined in claim 1 wherein the PDMS coating increases a surface area of the inner surface of the extraction vial by at least three times.

5. The system as defined in claim 1 wherein the thin film coating may be any suitable thin film coating material that does not interfere with the sorbent performance of the PDMS particles.

6. The system as defined in claim 1 wherein the PDMS coating is suitable for adsorbing or absorbing semi-volatile organic compounds (SVOCs) and volatile organic compounds (VOCs).

7. A method for increasing a surface area of particles for extracting analytes from a solution, said method comprising:
providing an extraction vial for extracting analytes from solution;
disposing a thin film coating on an inner surface of the extraction vial; and disposing a coating of polydimethylsiloxane (PDMS) particles on the thin film coating, wherein the PDMS coating adheres to the thin film coating and increases a surface area of the inner surface of the extraction vial, and wherein the PDMS is a sorbent material.

8. The method as defined in claim 7 wherein the method further comprises conditioning the PDMS coating by heating the extraction vial and evaporating a solvent between the PDMS particles.

9. The method as defined in claim 8 wherein the method further comprises forming pores in the PDMS coating during cross linking and conditioning of the PDMS coating.

10. The method as defined in claim 8 wherein the method further comprises extracting analytes from a liquid, said method comprising:
pouring a solution containing analytes into the extraction vial;
waiting a sufficient period of time for the analytes in the solution to be absorbed or adsorbed by the PDMS coating;
pouring the remaining solution from the extraction vial; and
sealing the extraction vial.

11. The method as defined in claim 10 wherein the method further comprises:
heating the extraction vial to thereby push the analytes into a headspace volume inside the extraction vial; and
delivering the analytes to a measuring instrument for detecting and measuring the analytes in the extraction vial.

12. The method as defined in claim 11 wherein the method further comprises increasing sensitivity of a detection system because of an increased volume of analytes in the extraction vial because of the PDMS coating.

13. The method as defined in claim 11 wherein the method further comprises decreasing the time to perform the extraction of the analytes from the solution by eliminating a step of heating the extraction vial to remove excess water.

14. The method as defined in claim 11 wherein the method further comprises decreasing the time to reach headspace equilibrium because of a higher concentration of the analytes in the PDMS coating.

15. The method as defined in claim 11 wherein the method further comprises improving extraction efficiency by increasing the surface area and the volume of the PDMS coating in the extraction vial.

16. The method as defined in claim 10 wherein the method further comprises performing re-extraction of the analytes from an extraction vial, the method comprising:
adding a solvent to the extraction vial;
allowing the solvent to evaporate from the extraction vial;
extracting a solvent-free sample from the extraction vial; and
delivering the solvent-free sample to a measuring instrument.

17. The method as defined in claim 11 wherein the method further comprises reducing the effect of water on an analysis process used with thermal desorption, purge and trap, head space or GC/GCMS.

18. A method for improving sample extraction and concentration of trace organic compounds found in an aqueous sample, said method comprising:
providing an extraction vial for extracting analytes from solution;
disposing a thin film coating on an inner surface of the extraction vial;
disposing a coating of polydimethylsiloxane (PDMS) particles on the thin film coating, wherein the PDMS coating adheres to the thin film coating and increases a surface area of the inner surface of the extraction vial, and wherein the PDMS is a sorbent material; pouring a solution containing analytes into the extraction vial;
waiting a sufficient period of time for the analytes in the solution to be absorbed or adsorbed by the PDMS coating;
pouring the remaining solution from the extraction vial;
sealing the extraction vial;
heating the extraction vial to thereby push the analytes into a headspace volume inside the extraction vial; and
delivering the analytes to a measuring instrument for detecting and measuring the analytes.
